(19) United States
(12) Patent Application Publication
(10) Pub. No.: US 2011/0209675 A1
(43) Pub. Date: Sep. 1, 2011

(54) Adjustable Fit Disposable Male Dog Diaper or Post Surgical Protective Wrap

(76) Inventor: Barbara Esperon, Cleveland, OH (US)

(21) Appl. No.: 12/713,171

(22) Filed: Feb. 26, 2010

(51) Int. Cl. A01K 23/00

(52) U.S. Cl. 119/868

(57) ABSTRACT

A male dog diaper of the present invention is specifically adapted for the male dog or 4 legged animal anatomy. The diaper includes a moisture barrier, a liner bonded to the moisture barrier, and an absorbent assembly sandwiched therebetween. The moisture barrier is gathered along each of its longitude sides edges between terminal points. The moisture barrier is gathered along its elasticized sides.

A male dog diaper is disposable. In addition, the diaper is for removable emplacement and securement circumferentially about a dog's rear torso and his inguinal region. A lower body sheet and upper body “Male Dog Diaper”, together with Velcro™ like stretch tabs, allow such wrap-around emplacement and securement without slipping, gathering or “bunching up”, and, together with removable engagement via the Velcro™ like stretch tabs, maximum comfort is afforded the dog. Highly absorbent material fixedly carried by the body sheet absorbs and retains body fluids, such as urine, discharged by the dog.

### CROSS-REFERENCE TO RELATED APPLICATION

This application claims the benefit of provisional patent application Ser. No. 61/208,470 filed 2009 Feb. 25 by the present inventor.

### BACKGROUND—PRIOR ART

The following is a tabulation of some prior art that presently appears relevant:

U.S. PATENT DOCUMENTS-DESIGN PATENTS

| Patent | Title | Issue Date | Inventor(s) | Class |
|---|---|---|---|---|
| D329927 | Sanitary garment for an | Sep. 29, 1992 | Thomas | D30/145 |
| | animal | | | |
| D334252 | Sanitary garment | Mar. 23, 1993 | Stubbs | D30/144 |
| | for animals | | | |
| D352577 | Garment for female | Nov. 15, 1994 | Shover | D30/145 |
| | canines | | | |
| D383259 | Diaper for Male Dogs | Sep. 02, 1997 | Post | D30/145 |
| D406410 | Pet diaper | Mar. 2, 1999 | Pasqua | D30144; |
| | | | | D24126 |

U.S. PATENT DOCUMENTS-UTILITY PATENTS

| Patent | Title | Issue Date | Inventor(s) | Class |
|---|---|---|---|---|
| 1,733,997 | Catamenial bandage | Oct. 29, 1929 | Marr | n/a |
| 3,141,443 | Protective cover for dogs | Jul. 21, 1964 | Huey | 119/143 |
| 3,211,132 | Training garment for domestic | Oct. 12, 1965 | Hersh | 119/143 |
| | pets | | | |
| 3,738,330 | Protective covering device for | Jun. 12, 1973 | Alofsin | 119/143 |
| | animals | | | |
| 3,792,687 | Animal waste receiving device | Feb. 19, 1974 | Ehrman | 119/95 |
| 3,817,217 | Sanitary refuse receiver and | Jun. 18, 1974 | Matuka et al. | 119/95 |
| | harness | | | |
| 3,875,903 | Pet pampers | Apr. 08, 1975 | Sarvary | 119/95 |
| 4,290,386 | Dog sanitary device | Sep. 22, 1981 | Eiriksson | 119/95 |
| 4,527,991 | Small animal protective garment | Jul. 9, 1985 | Msarsa | 604/399 |
| 4,577,591 | Incontinence and protective | Mar. 25, 1986 | Wesseldine | 119/143 |
| | device for animals | | | |
| 4,699,622 | Disposable diaper having an | Oct. 13, 1987 | Toussant et al. | 604/389 |
| | improved side closure | | | |
| 4,813,949 | Dog diaper | Mar. 21, 1989 | O'Rourke | 604/391 |
| 4,917,683 | Canine seasonal panties | Apr. 17, 1990 | Thompson | 604/387 |
| 4,996,949 | Disposable dog diaper | Mar. 05, 1991 | Wunderman et al. | 119/143 |
| 4,779,573 | Device with pouches for | Sep. 15, 1992 | Vidal | 119/95 |
| | receiving animal waste | | | |
| 5,226,386 | Absorbent urine detector for | Jul. 13, 1993 | Thoma | 119/95; |
| | training animals | | | |
| 5,234,421 | Diaper for Incontinent Dogs | Aug. 10, 1993 | Lowman | 604/385.1 |
| 5,555,847 | Dog diaper | Sep. 17, 1996 | Kelly | 119/850 |
| 5,558,659 | Incontinence Articles for Males | Sep. 24, 1996 | Sherrod et al. | 604/385.2 |
| 5,662,640 | Puppy training diaper | Sep. 02, 1997 | Daniels | 604/392 |
| 5,954,015 | Disposable diaper for animals | Sep. 21, 1999 | Ohta | 119/850 |
| | and method of manufacture | | | |
| 6,142,105 | Securely fitting pet diaper | Nov. 7, 2000 | McKnight | 119/850; |
| 7,195,618 | Diaper for Male Pet | Mar. 27, 2007 | Ikegami | 604/351; |
| 6,368,313 | Dog diaper system | Apr. 09, 2002 | Howard | 604/393; |
| 6,371,950 | Incontinence Article for males | Apr. 16, 2002 | Roslansky et al. | 604/385.19 |

U.S. PATENT DOCUMENTS-PATENT APPLICATIONS

| Patent | Title | Issue Date | Inventor(s) | Class |
|---|---|---|---|---|
| 9/974,229 | Dog diaper | Oct. 10, 2001 | Soares et al. | 119/850 |
| 10/709,369 | Male Dog | Mar. 24, 2005 | Hall | 119/869 |
| | Garmentfor | | | |
| | Use as Diaper | | | |
| 10/431,227 | Dog diaper | May 07, 2003 | Soares et al. | 119/850 |
| 11/364,921 | Pet diaper | Mar. 01, 2006 | Poh-Beyerlein | 119/869 |
| | system | | et al. | |
| 11/546,495 | Reusable and | Jun. 07, 2007 | Gribben | 604/392; |
| | Disposable | | | |
| | Diaper for Dogs | | | |

US Class 119/95, 119/850, 119/869, 604/391, 602/79

Main US Class Animal Husbandry; Surgery.

Field of Search 119/143, 119/29, 119/850, 119/869, 119/95; 128/157; 604/308, 604/345, 604/346, 604/351, 604/385.09, 604/385.1, 604/386, 604/387, 604/389, 604/391, 604/392, 604/393, 604/399; D24/124, D24/125, D24/126; D30/144, D30/145; 602/79, 602/61

1. Technical Field

This invention relates to a disposable male pet diaper for removable emplacement circumferentially about the rear torso of a dog and its inguinal region to absorb and retain body fluids, such as urine, discharged by the dog.

2. Background

### Technical Problem

There is a need for a disposable absorbent male pet diaper for relatively simple and easy placement circumferentially about a pet's rear torso and its inguinal region (region of the groin) to absorb and retain body fluids, such as urine, discharged by the pet to prevent soiling while traveling; prevent soiling of upholstery, carpets and furniture; dissipate the effects which would otherwise be present of odors and unsanitary conditions from such discharges; and wherein, the diaper prevents the pet, particularly a male dog, from urinating and marking in unwanted areas; prevents impregnation a female pet; lessen the embarrassment of when a humping or mounting another pet; protects a wound from dirt and germs, provides the owner of a pet with the ability to easily change wound dressing and/or packing underneath the wrap without having to discard the wrap.

Many pets have one or more of the following characteristics and/or problems: urinating in undesirable places; marking in undesirable places; excitable urination problem; urinary incontinence; mounting and humping; impregnating female pets; infected wounds due to dirt and germs in the inguinal region.

Over the recent years, there has been an explosion of products marketed and sold to deal with pet issues as describe above. Everything from training floor pads, poop bags, stain/odor removers/eliminators, urine removers, urine detectors, other cleaning products to pet diapers are now available to help pet owners.

There are many drawbacks to the current pet diapers on the market. There are several main types of pet diapers: pamper style, harness type, and belly bands. There are disposable and/or non-disposable diapers available in the market.

The most common pet diaper sold in the USA has the structure based on a pamper style diaper for human and there is no difference between male-use and female-use whereby the diaper for a pet has the structure that a length of a diaper is shorter than the length of the inguinal area of the pet. However, different from human, with respect to the pet which is four-legged walking animal, a position of the urethral opening largely differs between the male and the female. Particularly, with respect to a type of dog having short legs and an elongated trunk such as a dachshund, the urethral opening of the male dog is present at the center portion of the trunk.

As a result, these diapers do not fit and/or provide the need protection for male dogs. In addition, these diapers slide off male dogs and/or male dog urine sprays (squirts) out of the diaper because of the anatomical structure of the dog's penis and the location of their urethra.

Disposable style are limited to the pamper style similar to a human/baby/infant type of diaper. These throw-away diapers are more suited for female dogs in heat. Typically there is a dog tail opening that cover the anus. When a dog poops in a diaper, it is extremely difficult to clean and/or pick feces (especially soft feces) out from a pet fur/hair. Another problem is the dog tail opening is too large, leakage can occur. In addition, pamper style diapers are uncomfortable for most dog because it's restricted feel to the pets.

Non-disposable diapers come in several styles: pamper-like style, harness-like-style, belly band-like style. Prior art and personal experience shows the disadvantages of each type as seen below:

| pamper | harness | belly band | Disadvantages/Drawbacks |
|---|---|---|---|
| | [symbol] | [symbol] | a) 100% disposable type not currently available on the market |
| [symbol] | [symbol] | [symbol] | b) Expensive to the buyer |
| [symbol] | | | c) Design more suited for female dogs |
| [symbol] | | | d) Slips/Slides off more easily on male dogs-more difficult to keep on. |
| [symbol] | [symbol] | | e) Problem when dog poops-difficult to clean hair and fur |
| [symbol] | [symbol] | | f) Leakage around the tail opening |
| [symbol] | | | g) Male dog urine strays (squirts) out of diaper/garment |
| | [symbol] | [symbol] | h) Requires a pad and/or liner to be affixed to the diaper/garment prior to use and/or |
| | | | requires garment to be washed and dried before being able to use again |
| [symbol] | [symbol] | [symbol] | i) May or may not hook and loop waist tabs/wings |
| [symbol] | [symbol] | [symbol] | j) May or may not have elasticized sides or cuffs around waist |
| [symbol] | [symbol] | [symbol] | k) If non-disposable type, may get smelly and unsanitary if urine and/or other fluids |
| | | | leak onto garment |
| [symbol] | [symbol] | [symbol] | l) Do not have accordion-stretch ™ like tabs/wings which provides for all-around |
| | | | stretch system |
| [symbol] | [symbol] | | m) Difficult to put on pet. |
| [symbol] | [symbol] | [symbol] | n) Disposable pads and/or liners move and urine and/other fluids leak on to garment |
| | | | thus creating an unsanitary situation and terrible odor |
| [symbol] | [symbol] | [symbol] | o) When dealing with non-disposable diapers/garments, you may need one than one |
| | | | diaper/garment, in the event, the one placed on pet gets urine and/or other |
| | | | discharges on it. |
| [symbol] | [symbol] | [symbol] | p) Insert disposable pads and/or liners are expensive. |

To mediate the drawbacks of current pet diapers on the market, there is a great need for a disposable diaper/garment that is contoured for comfortable fit, is constructed to prevent leakages, and is efficiently, produced.

### SUMMARY OF THE INVENTION

In response to the discussed difficulties and problems encountered in the prior art, a new adjustable fit disposable male dog diaper/garment (“male dog diaper”) has been developed. Absorbent articles of the present invention comfortably contain the male dog genitalia, reduce leakage and promote dryness. In one embodiment, a “male dog diaper” of the present invention has longitudinal and transverse axes and includes a moisture barrier formed of a liquid impermeable material. The moisture barrier defines a front end, a back end longitudinally spaced from the front end, and a pair of side edges extending between the front and back ends.

The “male dog diaper” also includes an absorbent assembly and a body side liner formed of a liquid permeable material. The body side liner is bonded to the moisture barrier to sandwich the absorbent assembly there between. The moisture barrier is gathered along each side edge between forward and rearward terminal points. A pair of elasticized containment flaps is disposed on the liner so that each containment flap extends longitudinally toward the front end to a position to the back end of the moisture barrier.

The “male dog diaper” is also gathered along its sides. An elasticized back pouch member is connected to at least one of the moisture barrier and the body side liner along the back end of the article.

The various aspects of the invention can provide pouch-like member structure which can more reliably and more effectively maintain an open position when the associated diaper is being worn. In addition, the open pouch-like configuration can be sustained while avoiding excessive irritation of the wearer's skin. The arrangements of the constituent components and the combination of operational parameters, such as the controlled stiffness and the controlled articulation of the back pouch member, can advantageously provide an improved absorbent structure which can have less leakage, and can afford increased comfort to the wearer.

This design yields a relatively short article that is targeted for male pet urine incontinence and/or marking. In use, diaper is wrapped around of the wearer so that the wearer generally does not sit on the article. Thus, the absorbent assembly is less subject to bunching and twisting during use. The “male dog diaper” is gathered along the sides to form a cupped region in which the penis of the wearer resides. Also, the penis of the wearer is maintained over the absorbent assembly by the elastic containment flaps.

This aspect of the invention provides an especially dry environment for the wearer. The retaining member holds the penis of the wearer in its proper position, while the cover protects against leakage. The penis is held in the compartment.

As can be seen from the foregoing, a “male dog diaper” of the present invention provides urine incontinent 4 legged male pets a dry environment for the penis, in a cupped structure that is comfortable and discreet to wear. Articles of the invention can be efficiently manufactured.

Numerous other benefits and advantages of the present invention will appear from the following description. In the description, reference is made to the accompanying drawings which illustrate preferred embodiments of the invention. Such embodiments do not represent the full scope of the invention. Reference should therefore be made to the claims herein for interpreting the full scope of the invention.

The present invention is a modification of a modern conventional disposable baby diaper, adapted for new uses for a pet.

The present invention has an adjustable fit and is a throw-away diaper or bandage wrap. It is constructed with multiple plies of material which locks away wetness. The outer or exposed ply is waterproof strength ply. The intermediate ply is an absorbent ply which preferably extends close to and parallel to the edges but it need not extend completely to the edges of the outer ply.

The present invention has been made by focusing on these drawbacks which are presented in the prior art and its an object of the present invention to provide a diaper for a pet which can surely trap bodily fluids, like urine by covering a urethral opening of a male dog and/or any wounds on the torso of the pet.

The present invention contributes to the solution of the discussed problems by providing a waterproof, disposable diaper whose associated structures and functional attributes permit relatively simple and easy placement circumferentially about the dog's rear torso and inguinal region to absorb and retain body fluids discharged by the dog.

More particularly, the invention pertains to a disposable absorbent diaper adapted specifically for use by male dogs, and a method of using such diaper.

Difficulty has been experienced by pet owners heretofore with dog diapers because complexity of finding diapers that fit male dogs. It is hence an object of this invention to provide a diaper of the character described having means to easily adjust the effective inguinal region dimension.

Another object of the invention is to provide a diaper of the character described having a shape similar to a belly band/wrap.

Yet another object of this invention is to provide a diaper of the character described in which the overlapping taps/wings are stretchable and have Velcro™ like fastening system to secure the diaper around the torso of the pet.

Still another object of the invention is to provide a diaper of character described which is stretchable in a circumferential direction, which shall be easy to adjust, comfortable to wear and which shall yet be practical and efficient in a high degree of use. The diaper is stretchable because the overlapping tabs/wings are made of stretchable material. The tabs/wings are releasable and adjustable because of the Velcro™ like fastening system.

A further object of this invention is to provide a strong garment of character described which shall be relatively inexpensive, which may be fabricated by baby/infant diaper manufacturers.

The above objects and further objects and advantages of the invention will become more readily apparent from the following description of a preferred embodiment of the invention and in conjunction with the accompany drawings.

### ADVANTAGEOUS EFFECTS OF INVENTION

The “Male Dog Diaper” prevents male dogs from urinating and/or marking while traveling and/or at home. The invention prevents the dog from urinating directly on walls, upholstery, carpets, floors, and/or furniture. The invention dissipates the effects which would otherwise be present of odors and unsanitary conditions from such discharges, and wherein, the diaper prevents the male dog from urinating and marking in unwanted areas; prevents impregnation a female dogs; protects a wound from dirt and germs, provides the owner of a dog with the ability to easily change wound dressing and/or packing underneath the wrap without having to discard the wrap.

The “Male Dog Diaper” is especially useful for untrained puppies and dogs, special needs dogs, and/or dog who have a marking problem. The “Male Dog Diaper” absorbs wetness (urine or other discharge) and does not leak.

Unlike other inventions and patents, the “Male Dog Diaper” is truly throwaway able, it is made up of the same composition of a modern day conventional disposable baby/infant diaper and/or conventional incontinence diaper. The preferred embodiment's fabrication would be disposable baby/infant diaper manufacturer due to the economics of scale and the efficiencies that could be achieved. Which would in turn, lower the direct cost of production and allow the cost to pet owners and a like to be less costly than current related products currently available in the market.

The adjustable fit disposable male dog diaper/garment's size is adjustable because of the Velcro™ like (hook and loop type fastener) closure. The diaper provides an improved fit and adjustability due to the contoured form and stretchable tabs/wings, which provides more protection where a male dog needs it most; and ease-of-use. The said diaper is removable and can be put on and/or remove like a regular baby diaper. However, the said diaper is fastening at the ends. See drawings for additional details.

The adjustable fit disposable male dog diaper/garment's elasticized cuffs assist with odor control and the prevention of body fluid leakages.

The “Male Dog Diaper” is designed to wrap around the dog's groin area and back and fasten with stretchable Velcro™ like (hook and loop type fastener) tab closures. When the dog lifts his leg to peep and/or mark his area, the diaper captures his urine and/or discharge.

The “Male Dog Diaper” is curved to fit the shape of the dog's groin area allowing freer movement of the hind legs as well as preventing lateral movement of the diaper up the dog's body. The curved shape of the diaper is designed to prevent the diaper from twisting around the dog's body or up the dog's back. The form-fitting diaper has great leakage protection and provides better comfort because of its curved shape.

The curved shape and the disposableness of the “Male Dog Diaper” are unique features that improve the performance and distinguish this dog diaper from simple “belly bands” that are non-disposable, flat, and wrap around the dog. The elasticized center of the diaper holds the dog's urine and in most in most cases precludes it from slipping out place when the dog leg is raised.

The “Male Dog Diaper” may be manufactured in different sizes to accommodate small to large size dogs. The stretchable tabs/wings may also be manufactured in different shapes and materials.

This invention will tremendously improve the pet's and owner's quality of life. The advantages of this diaper over prior art, patents, and current pet diapers available in the market are as follows:

1. The “Male Dog Diapers” are affordable unlike common pet diapers that typically cost $10 for 12 diapers. Baby diapers cost $6 for 34 diapers. Since we are going to benefit from the economy of scale that come from modifying a human/baby diaper.

2. The “Male Dog Diapers” are especially designed for male dogs.

3. The “Male Dog Diapers” are disposable.

4. The “Male Dog Diapers” are easy to use.

5. The “Male Dog Diapers” can be removed and put back on easily. For example, the diaper can be used while the pet is at home. Once outdoor, the diaper can be removed and put back on upon return arrival to home.

6. The “Male Dog Diapers” provide a better fit because they are adjustable and have stretchable members.

7. The “Male Dog Diapers” better protection against leakages because of gasket cuffs and contour shape.

8. The “Male Dog Diapers” raw materials can easily be to convert to environmental friendly materials.

9. They can be used for other purposes, for example, as a post surgical protective wrap, when my pet sprayed, she keep licking her incision and pulling her staples off before time. The diaper would have been useful in protecting the area until the area was better healed. The “male dog diaper” can be used to prevent male dog impregnating female dogs.

### BRIEF DESCRIPTION OF THE DRAWINGS

So that the manner in which the above recited features, advantages, and objects of the present invention are attained and can be understood in detail, more particular description of the invention, briefly summarized above, may be had by reference to the embodiment thereof which is illustrated in the appended drawings.

While the foregoing summarizes the structure of the present disclosure, details of its construction and its mode of use or installation are set forth below with the description of the preferred embodiment.

These objects and other objects of the invention should be discerned and appreciated from the description of the preferred embodiment taken in conjunction with the drawings, wherein like reference numerals refer to similar parts throughout the several drawing figures.

It is to be noted, however, that the appended drawings illustrate only a typical embodiment of this invention and is therefore not to be considered limiting of its scope, for the invention may admit to other equally effective embodiments.

### DRAWINGS—FIGURES

In the drawings, closely related figures have the same number.

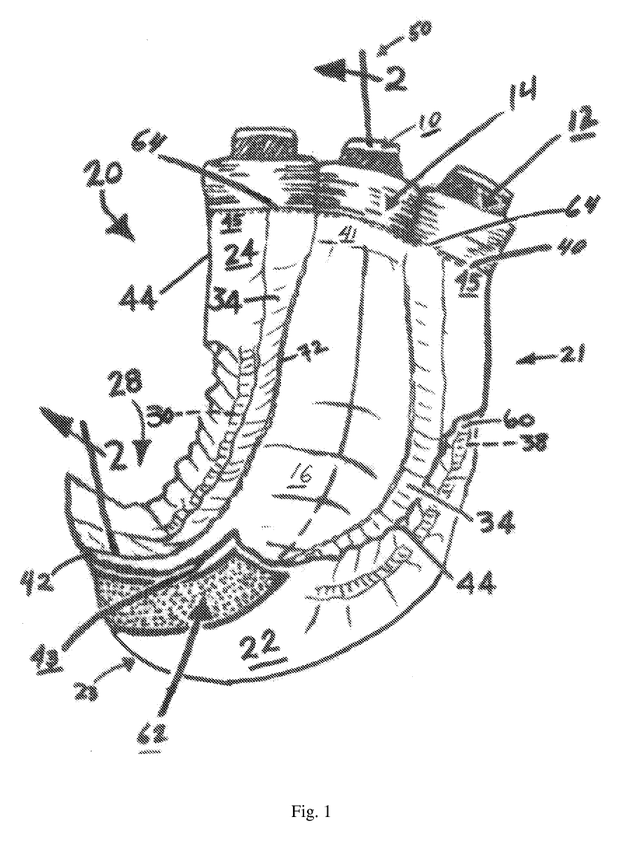

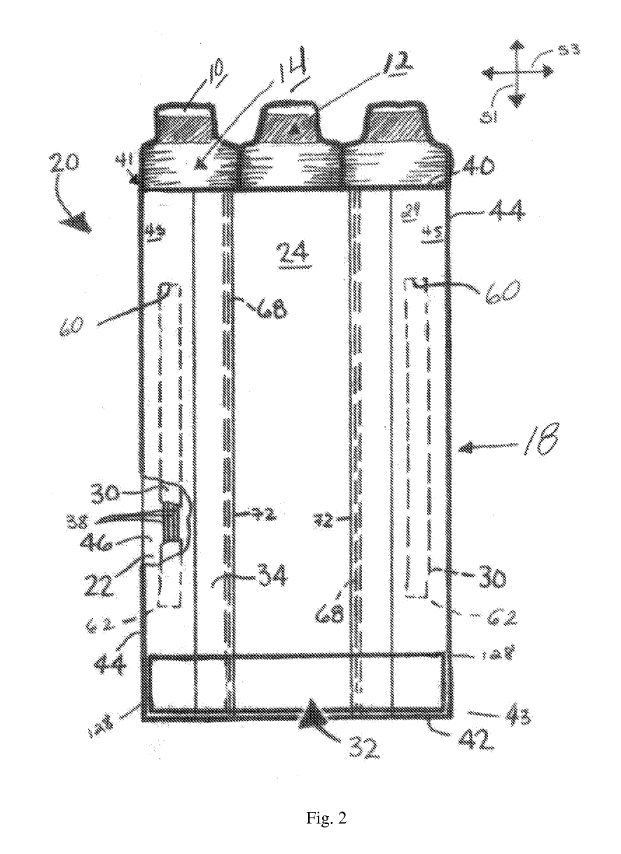

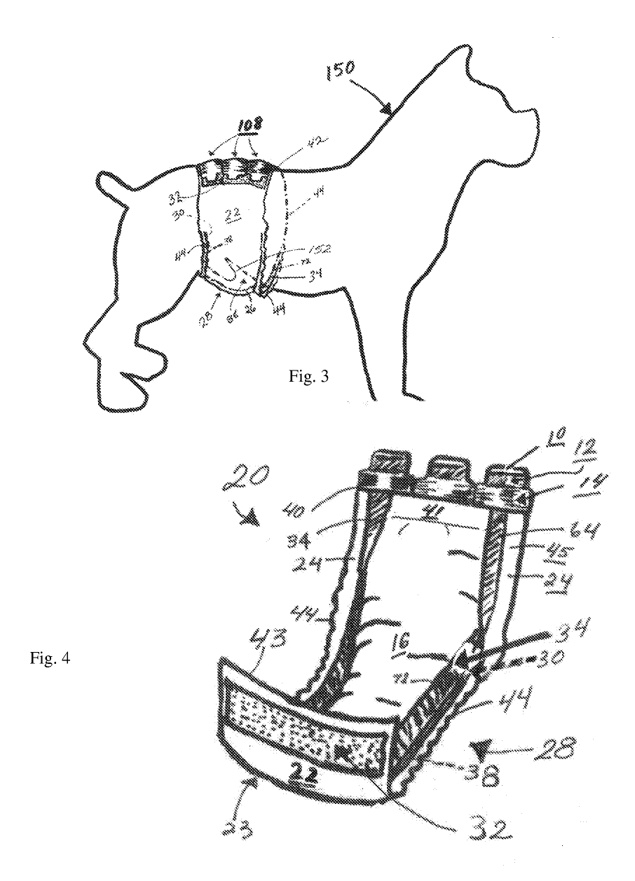

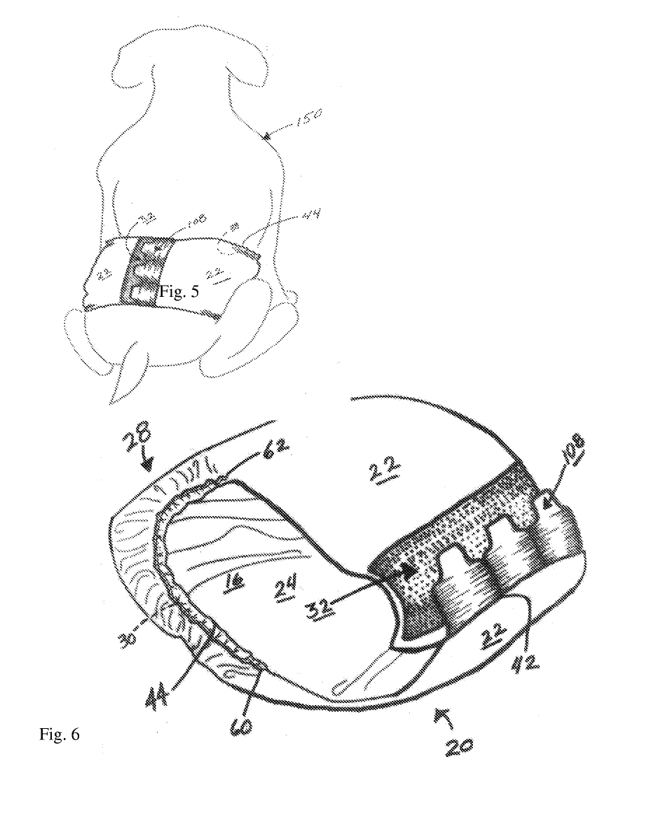

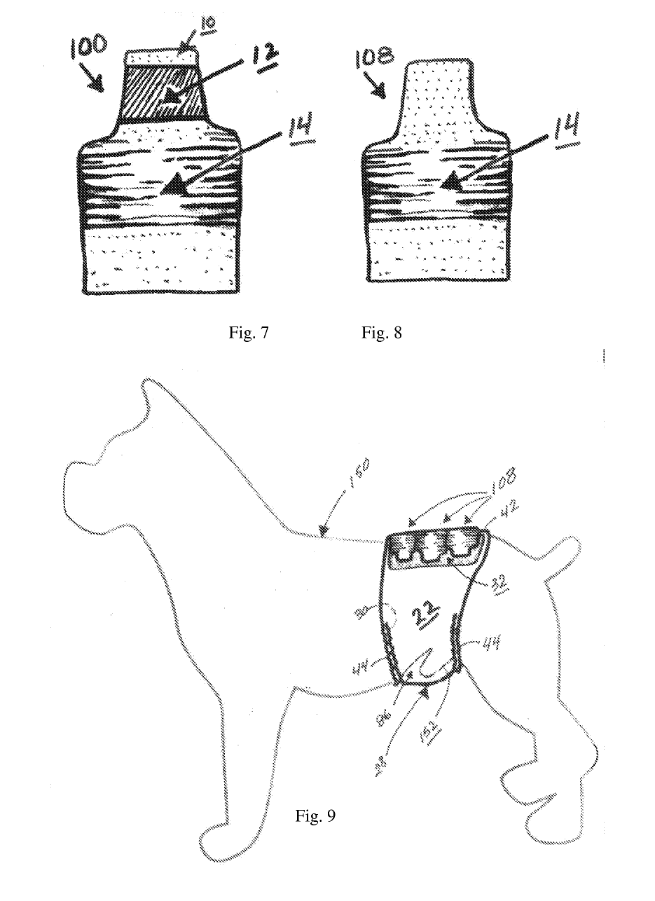

### DRAWINGS—REFERENCE NUMBERS

| Ref. # | Description | FIG. 1 | FIG. 2 | FIG. 3 | FIG. 4 | FIG. 5 | FIG. 6 | FIG. 7 | FIG. 8 | FIG. 9 |
|---|---|---|---|---|---|---|---|---|---|---|
| 2 | Line for description of the drawings | 2 | | | | | | | | |
| 10 | Top part of stretchable tab(s)/wing(s) | 10 | 10 | | 10 | | | 10 | | |
| 12 | Velcro ™ like “Hook” side fastener | 12 | 12 | | 12 | | | 12 | | |
| | member Panel | | | | | | | | | |
| 14 | Stretch or Accordion Section of | 14 | 14 | | 14 | | | 14 | 14 | |
| | stretchable tab/wing member | | | | | | | | | |
| 16 | Back pouch member (intermediate | 16 | | | 16 | | 16 | | | |
| | portion) | | | | | | | | | |
| 18 | Boundary space | | 18 | | | | | | | |
| 20 or 21 | Male dog diaper | 20 | 20 | | 20 | | 20 | | | |
| 22 or | Moisture barrier liquid impermeable | 22 | 22 | 22 | 22 | 22 | 22 | | | 22 |
| 48 | outer surface | | | | | | | | | |
| 23 | Outer cover member | 23 | | | 23 | | | | | |
| 24 | Body side liner | 24 | 24 | | 24 | | 24 | | | |
| 26 | Absorbent assembly | | | 26 | | | | | | |
| 28 | Body conforming cupped region | 28 | | 28 | 28 | | 28 | | | 28 |
| 30 | Longitude gathering members | 30 | 30 | 30 | 30 | | 30 | | | 30 |
| 32 | Velcro ™ Like “Loop” fastener | | 32 | 32 | 32 | 32 | 32 | | | 32 |
| | member panel on the outer side of | | | | | | | | | |
| | the diaper | | | | | | | | | |
| 34 | Containment flaps | 34 | 34 | 34 | 34 | | | | | |
| 38 | Elastic members | 38 | 38 | 38 | 38 | 38 | | | | |
| 40 | Front end | 40 | 40 | | 40 | | | | | |

| Ref # | Description | FIG. 1 | FIG. 2 | FIG. 3 | FIG. 4 | FIG. 5 | FIG. 6 | FIG. 7 | FIG. 8 | FIG. 9 |
|---|---|---|---|---|---|---|---|---|---|---|
| 41 | Laterally extending front end | 41 | 41 | | 41 | | | | | |
| 42 | Back end | 42 | 42 | 42 | | | 42 | | | 42 |
| 43 | Laterally extending back end | 43 | 43 | | 43 | | | | | |
| 44 | Side edges | 44 | 44 | 44 | 44 | 44 | 44 | | | 44 |
| 45 | Outer edges of a pair of laterally | 45 | 45 | | 45 | | | | | |
| | opposed side margins | | | | | | | | | |
| 46 | Inner surface | | 46 | | | | | | | |
| 50 or 51 | Longitudinal axis | 50 | 50 | | | | | | | |
| 53 | Transverse axis | | 52 | | | | | | | |
| 60 | Top terminal point | 60 | 60 | | | | 60 | | | |
| 62 | Bottom terminal points | 62 | 62 | | | | 62 | | | |
| 64 | Fixed edges | 64 | | | 64 | 64 | | | | |
| 68 | Elastic strains | | 68 | | | | | | | |
| 72 | Distal movable edge of the | 72 | 72 | 72 | 72 | | | | | |
| | containment flaps | | | | | | | | | |
| 86 | Compartment | | | 86 | | | | | | 86 |
| 100 | Front side (Inner side) of Stretchable | | | | | | | 100 | | |
| | Tab(s)/wings(s) | | | | | | | | | |
| 108 | Outer side of Stretchable tab(s)/wing(s) | | | 108 | | 108 | 108 | 108 | 108 | 108 |
| 128 | Laterally opposed end sections | | 128 | | | | | | | |
| 150 | *** Male dog torso | | | 150 | | | | | | 150 |
| 152 | *** Penis/groin area of male dog | | | 152 | | | | | | 152 |

### Main Components of the Present Invention by Reference Numbers

| Ref. | | |
|---|---|---|
| # | Descriptions | Material Characteristics |
| 22 | Diaper exterior | Waterproof and water-resistant material |
| 48 | | (moisture barrier liquid impermeable outer |
| | | surface) |
| 26 | Absorbent | Ultra absorbent assembly core material that locks |
| | assembly | away moisture and wetness |
| 108 | Stretchable | Stretch panel tabs/wings (recommend to use |
| | tab(s)/wing(s) | accordion-stretch ™Tab/wings) |
| 12 | “Hook” side | Bonded Velcro ™ like (hook and loop type |
| | fastener panel | fastener) “Hook” side fastener Panel which is |
| | | bonded on to a stretch panel tabs/ |
| | | wings to provide a round-about stretch system |
| | | for a secure, comfortable, and adjustable fit |
| 32 | “Loop” side | Bonded Velcro ™ like (hook and loop type |
| | fastener panel | fastener) “Loop” Fastener Panel |
| 34 | Containment | Containment flaps form a body-conforming |
| | flaps | cupped region |
| 38 | Elastic | Elastic sewn on to diaper forms a contractible |
| | members | gasketing cuff |

### DEFINITIONS

Within the context of this specification, each term or phrase below will include the following meaning or meanings:

(a) “bonded” refers to the joining, adhering, connecting, attaching, or the like, of two elements. Two elements will be considered to be bonded together when they are bonded directly to one another or indirectly to one another, such as when each is directly bonded to intermediate elements.

(b) “body fluids”—fluids and/or material discharged from the body and treatment of the body such as urine, blood, etc.

(c) “disposable” includes being disposed of after use, and not intended to be washed and reused.

(d) “disposed”, “disposed on”, “disposed with”, “disposed at”, “disposed near”, and variations thereof are intended to mean that one element can be integral with another element, or that one element can be a separate structure joined to or connected to or placed with or placed near another element.

(e) “elastic,” “elasticized” and “elasticity” include that property of a material by virtue of which it tends to recover its original size and shape after removal of a force causing the deformation.

(f) “front” and “back” are used to designate relationships relative to the garment itself and not necessarily any position the garment assumes when it is positioned on a wearer.

(g) “gathered” and “gatherable” refer to a material that is or can be drawn together such as in pleats or folds.

(h) “member” when used in the singular can have the dual meaning of a single element or a plurality of elements.

These definitions are not intended to be limiting, and these terms may be defined with additional language in the remaining portion of the specification.

### DETAIL DESCRIPTION OF THE PREFERRED EMBODIMENT

Preferred embodiment of the present invention are explained hereinafter conjunction with drawing. However, the present invention is not limited to this embodiment.

FIG. 1 of the drawings, is a perspective view of a “Male Dog Diaper” according to the present invention. FIG. 1 reference number 20 generally refers to the present invention.

FIG. 2 of the drawings, is a top plan view of a “Male Dog Diaper” 20 showing pouch members in a flat and stretched condition.

FIG. 3 of the drawings, is an enlarged side perspective view including a representation of a male dog anatomy while the diaper is in use.

FIG. 4 of the drawings, is an enlarged longitudinal section view taken generally from the side and including a representation of the male dog anatomy while diaper is in use.

FIG. 5 of the drawings, is an enlarged view taken generally from above and including a representation of the back of a male dog anatomy while the diaper is in use.

FIG. 6 of the drawings, is a 3D-view of a “Male Dog Diaper” 20 according to the present invention when closed and not in use.

FIG. 7 of the drawings, is a plan view of front side (inner side) of a stretchable tab used in a “Male Dog Diaper” 20 according to the present invention.

FIG. 8 of the drawings, is a plan view of the back side (outer side) of a stretchable tab/wing used in a “Male Dog Diaper” 20 according to the present invention.

FIG. 9 is an enlarged side view including a representation of a male dog anatomy while the diaper is in use.

In all the figures presented of the preferred embodiment use common reference numbers. The foregoing is a description of preferred embodiment's parts, characteristics, and descriptors for the making and using the present invention in conjunction with common reference number(s)that generally refers to the present invention: Line for description of the drawings 2; Top part of stretchable tab(s)/wing(s) 10; Velcro™ like “Hook” side fastener member Panel 12; stretch or accordion like folded section of stretchable tab/wing member 14; back pouch member (intermediate portion) 16; boundary space 18; “Male Dog Diaper” 20 or 21; moisture barrier liquid impermeable outer surface 22 or 48; outer cover member 23; body-side liner 24; absorbent assembly 26; body-conforming cupped region 28; longitude gathering members 30; Velcro™ like “Loop” fastener member panel on the outer side of the diaper 32; containment flaps 34; elastic members 38; front end 40; laterally extending front end 41; back end 42; laterally extending back end 43; Side edges 44; outer edges of a pair of laterally opposed side margins 45; inner surface 46; longitudinal axis 50 or 51; transverse axis 53; top terminal point 60; bottom terminal points 62; fixed edges 64; elastic strains 68; distal movable edge of the containment flaps 72; compartment 86; Front side (Inner side) of Stretchable Tab(s)/wings(s) 100; outer side of stretchable tab(s)/wing(s) 108; laterally opposed end sections 128; male dog torso 150; Penis area of male dog 152.

The preferred embodiment of a disposable “Male Dog Diaper” 20 according to the present invention is shown in FIGS. 1-9. The “Male Dog Diaper” 20 is specifically designed to address urinary incontinence and be compatible with the male dog anatomy. In general, the “Male Dog Diaper” 20 includes a moisture barrier 22, a body side liner 24, and an absorbent assembly 26 (see FIG. 2) sandwiched between the moisture barrier and liner. The “Male Dog Diaper” 20 has a body conforming cupped region 28 at one end (see FIGS. 1, 3, 4, 6 and 9) as a result of the interaction between two longitudinal gathering members 30 (see FIGS. 2-6 and 9). A pair of containment flaps 34 maintains the penis of the wearer in proper position relative to the “Male Dog Diaper” 20 and minimizes leakage. A pouch member is formed between moisture barrier 22 and the body side liner 24 along the back end margin 43 of the “Male Dog Diaper” 20. The components of the urinary incontinence “Male Dog Diaper” 20 will now be described in more detail.

The moisture barrier 22 is desirably formed from a flexible, gatherable material that is substantially liquid impermeable. The moisture barrier 22 has a front end 40, a back end 42 longitudinally spaced from the front end 40, and a pair of side edges 44 extending between the front and back ends 40 and 42. The pair of side edges 44 define the outer edges of a pair of laterally opposed side margins 45. The moisture barrier 22 also has opposite major surfaces designated inner surface 46 and outer surface 48.

For the “Male Dog Diaper” 20 to be worn around the waist of the dog. Where the moisture barrier 22 is gathered, such as by an elastic material, the length is measured with the moisture barrier 22 in a generally flat and stretched condition.

FIG. 2 is a representative plan view of the article 20 of the present invention in its flat-out, uncontracted state (i.e. with all elastic induced gathering and contraction removed). Portions of the structure are partially cut away to more clearly show the interior construction of the article 20, and the surface of the article 20 which contacts the wearer is facing the viewer. The pair of side edges 44 and the front and back ends 40 and 42 define a periphery in which the longitudinally extending pair of laterally opposed side margins is designated 45 and the laterally extending front and back end margins are designated 41 and 43 respectively.

The “Male Dog Diaper” typically includes a porous, liquid permeable body side liner 24; a substantially liquid impermeable moisture barrier 22; an absorbent assembly 26 (FIG. 3), positioned and connected between the body side liner 22 and the moisture barrier 22; and longitudinal elastic gathering members 30, such as leg elastics members 38. The absorbent assembly 26 may include a liquid storage layer. The body side liner 24, moisture barrier 22, absorbent assembly 26, and the longitudinal elastic gathering members 30 may be assembled in a variety of configurations. In addition, the “male diaper” may include a pair of containment flaps 34.

As representatively shown, the body side liner 24 and the moisture barrier 22 may be generally coextensive, and may have length and width dimensions which are generally larger that the corresponding dimensions of the absorbent assembly 26. The body side liner 24 is associated with and super imposed on the moisture barrier 22, thereby defining the periphery of the “Male Dog Diaper” 20. As used herein, the term “associated” encompasses configurations in which the body side liner 24 is directly joined to the moisture barrier 22 by affixing the body side liner 24 directly to the moisture 20 barrier 22, and configuration wherein the body side liner 24 is joined to the moisture barrier 22 by affixing the body side liner 24 to intermediate members which in turn are affixed to the moisture barrier 22. The body side liner 24 and the moisture barrier 22 can be affixed directly to each other in selected regions, such as in areas along the periphery of the “Male Dog Diaper” 20, by attachment means (not shown), such as adhesive, sonic bonds, thermal bonds, or any other attachment means known in the art. For example, a uniform continuous layer of adhesive, a patterned layer of adhesive, a sprayed pattern of adhesive, or an array of separate lines, swirls, or spots of construction adhesive may be used to affix the body side layer 24 to the moisture barrier 22. It should be readily appreciated that the above-described attachment means may also be employed to interconnect and assemble together the various other component parts of the “Male Dog Diaper” 20 described herein.

In various embodiments of the invention, the selected absorbent assembly 26 is positioned and operably secured between the body side liner 24 and the moisture barrier 22. The absorbent assembly 26 has a construction which is generally compressible, conformable, non-irritating to the wearer's skin, and capable of absorbing and retaining liquid body exudates. It should be understood that, for purposes of this invention, the absorbent assembly 26 may comprise a single integral piece of material, or alternatively, may comprise a plurality of individual separate pieces of material which are operably assembled together. Where the absorbent assembly 26 comprises a single, substantially integral piece of material, the material could include the desired structural features formed into selected spatial regions thereof. Where the absorbent assembly 26 comprises multiple pieces, the pieces may be configured as discrete layers or as other nonlayered shapes and configurations. Furthermore, the individual pieces may be coextensive or non-coextensive, depending upon the requirements of the product. It is preferred, however, that each of the individual pieces be arranged in an operable, intimate contact along at least a portion of its boundary with at least one other adjacent piece of the absorbent assembly 26. Preferably, each piece is connected to an adjacent portion of the absorbent assembly 26 by a suitable bonding and/or fiber entanglement mechanism, such as ultrasonic or adhesive bonding, or mechanical or hydraulic needling.

The absorbent assembly 26 (see FIG. 3) is disposed on the inner surface 46 of the moisture barrier 22 and is desirably sufficiently flexible to readily conform to the contour of the inner surface. The absorbent assembly 26 may be bonded to the inner surface 46 using adhesives or other suitable means.

The absorbent assembly 26 is sized to be shorter and narrower than the moisture barrier 22, and may be manufactured in a wide variety of sizes and shapes including T-shaped, I-shaped, rectangular, hourglass-shaped, or irregularly-shaped.

By way of example, the absorbent assembly 26 may be rectangular with a length.

Attached to the stretch tab 100 is provided with Velcro™ like hook and loop fasteners, having an accordion-like zone 14 that allows a certain amount of stretch. The Velcro-secured stretch tabs 100 thereby provide an adjusted supportive smooth fit to the inguinal region of the pet. The tabs can stretch and shrink as an accordion. The Velcro-secured stretch panels 100 thereby provide an adjusted supportive smooth fit. It is desirable for the stretch tabs 100 to stretch and expand to accommodate changes in the waist size of the pet due to eating, moving around and so on. Hook material 12 is fixed at the end stretch tab 100.

The Velcro-secured stretch tabs 100 strips can be attached to the respective end of the front end 40). The loop side member panel 32 is attached to the outer surface 22 by method of sewing or stitching, or preferably by gluing or fusing the base material.

The elastomeric member 38 is elongated at least a fraction of its relaxed length. The longitude gathering members 30 provides additional stretch around the waist of the pet and helps form a compartment (86) for his penis.

The wrap-around feature of the Stretchable Tabs 14, together with infinite adjustment afforded by the contact Velcro™ like portions, provides the phenomenon of both removable emplacement and securement of the dog diaper 20 functionally on the one hand, and maximum comfort for the dog Male Dog 150 on the other.

After the diaper 20 has been soiled, it can be easily and simply replaced by a new one.

The diaper 20 is easy to attach because it requires only minimal cooperation from the dog.

The diaper is attached while the dog is standing and facing away from the human operator effecting such attachment.

It is not necessary to effect any special positioning of the dog's legs or other body parts, and the diaper 20 will produce satisfactory results with a relatively broad range of positions.

The diaper 20 is attached around the dog's torso, not around or through the dog's legs, as, for example, is the case with a human infant's diaper.

As a result, the dog's natural range of movements are not restricted, namely: the dog can stand, even on its hind legs, sit, lie down, walk and even run naturally.

These functional attributes of the diaper 20 contribute to the dog's comfort and thereby reduce the likelihood of the dog's attempts to remove or destroy the diaper 20, either of which would reduce the efficacy of the diaper 20.

The simplest and recommended process for making a “male dog diaper” and/or post surgical protective wrap is to modify and/or adapt a contemporary human disposable diaper:

i. know the waist measurement needed and the weight of your dog.

ii. investigate available sizes, respective measurements sizes (length and width) and saturation capacity (light, regular, super duty, night time, etc.) of contemporary human disposable diapers.

iii. Select and obtain a contemporary human disposable diaper whose length is closest to the desired pet waist measurement and saturation capacity.

iv. Cut off the excess ruffle around leg opening area. Too much ruffle is unnecessary and it is cumbersome especially to male pets.

v. Remove the stretchable tabs from the sides of the diaper.

vi. reattach (sew, glue, bond) the tabs to the end that does not have Velcro™ like loop panel.

The recommended process for using a “male dog diaper” is as follows:

vii. Once you have access and/or made an adjustable fit disposable male dog diaper and/or post surgical protective wrap;

viii. Open the diaper;

ix. Place diaper circumference around your pet's waist and inguinal area.

x. Adjust and attach the Velcro™ Tabs panels according your pet's waist size.

xi. Whenever necessary or just as you would change a baby's diaper and/or a wound bandage or as recommended by your pet's doctor, change your pet's diaper.

xii. Once the diaper is saturated with bodily fluids, discard in the trash.

### CONCLUSION, RAMIFICATIONS, AND SCOPE

The improvement invented is a disposable dog diaper and/or post surgical protective wrap which specifically designed for male pets, particularly male dogs. The “male dog diaper” 20 is an anatomically form-fitting, generally self-adjusting disposable absorbent garment, resiliently stretchable preferably in a cross-body direction.

The invention is not to be considered as being limited by the illustrative embodiment described here. Although the embodiment contains much specificity, these should not be constructed as limiting the scope of the embodiment but as merely providing illustration. For example, the Velcro™ like (hook and loop type fastener) tabs/wings can be combined into one shape or panel, and/or have other shapes; the absorbent material can have other shapes and/or be replaced by a different biodegradable absorbent materials. In particular, it is possible to vary the shape of the diapers/bandages described, and also the composition of the absorption body and other components of no importance for fastening.

Additionally, use of the stretchable tabs provides better protection on a greater variety of dogs, animals, and/or patients. Similar to how one could go to the store and purchase infant diapers in a variety of sizes, this invention can be scaled for a particular size and be scaled for larger or smaller dogs, animals, and/or patients.

While the foregoing is directed to the preferred embodiment, the scope thereof is determined by the appended claims and their legal equivalents, rather than by the examples given.

I claim:

1. A male dog diaper having a longitudinal axis and a transverse axis, the male dog diaper comprising:
a) a moisture barrier including a liquid impermeable material, the moisture barrier defining a front end, a back end longitudinally spaced from the front end, a pair of side edges extending between the front and back ends, an inner surface and an opposite outer surface.
b) an absorbent assembly disposed on the inner surface;
c) a liner including a liquid permeable material, the liner bonded to the moisture barrier and sandwiching the absorbent assembly therebetween;
d) means for gathering the moisture barrier along each side edge between terminal points.
e) a pair of elasticized containment flaps disposed on the liner.
f) attachment means disposded on the outer surface of the moisture barrier.

2. A male dog diaper of claim 1 wherein the diaper is closed via stretchable Velcro-like Tabs.

3. A male dog diaper of claim 1 for removable emplacement circumferentially about and securement with the rear torso of a male dog and his inguinal region.

4. A male dog diaper of claim 2 designed for male dogs.

5. A male dog diaper of claim 4 is disposable.

6. A male dog diaper of claim 1 is easy to use.

7. A male dog diaper of claim 6 is can be removed and put back on easily. For example, the diaper can be used while the pet is at home. Once outdoor, the diaper can be removed and put back on upon return arrival to home.

8. A male dog diaper of claim 2 provides a better fit because they are adjustable and have stretchable members.

9. A male dog diaper of claim 1 provides better protection against leakages because of gasket cuffs and contour shape.

10. A male dog diaper of claim 1 provides raw materials can easily be to convert to environmental friendly materials.

11. A male dog diaper of claim 2 can be used for other purposes, for example, as a post surgical protective wrap, when my pet sprayed, she keep licking her incision and pulling her staples off before time. The diaper would have been useful in protecting the area until the area was better healed. The “male dog diaper” can be used to prevent male dog impregnating female dogs.
